(19) United States
(12) Patent Application Publication
(10) Pub. No.: US 2006/0047597 A1
(43) Pub. Date: Mar. 2, 2006

(54) Options calculator

(76) Inventors: Michael Homer, Golden, CO (US); Glenn Weadock, Golden, CO (US)

Correspondence Address: R. Blake Johnston;PIPER RUDNICK LLP, P.O Box 64807, Chicago, IL, 60664-0807, US

(21) Appl. No.: 10/928,231

(22) Filed: Aug. 27, 2004

(51) Int. Cl. G06Q 40/00

(52) U.S. Cl. 705/37

(57) ABSTRACT

A calculator for analyzing options and option spreads includes a memory storage having software where the software permits a user to input into the system a type of transaction, a type of option contract, a number of option contracts, a strike price and a premium price. A processor in communication with the memory storage uses the software to calculate a maximum profit, maximum loss and breakeven level based on the type of transaction, type of option contract, number of option contracts, the strike price and the premium price entered by the user. A display is in communication with the memory storage and the processor and presents to the user the maximum profit, maximum loss and breakeven level as well additional information. The calculator also provides error trapping and a help function that includes a glossary of terms.

### BACKGROUND OF THE INVENTION

The present invention generally relates to securities and, more specifically, to an options calculator for teaching the fundamentals of options and option spreads and analyzing option strategies and option spreads.

Investors typically face a wide variety of investment opportunities. If an investor is interested in securities, he or she has a number of investment vehicles or choices available. Two such choices are options and option spreads.

An option is a contract that is entered between two investors. An option is a right, but not an obligation, to buy or sell a stock for a certain price on or before a specific date (the expiration date of the option). The buyer of the contract is referred to as the holder, buyer or long of the option contract. The seller of the option contract is known as the writer, seller or short of the option contract. One option contract equals 100 shares of the underlying stock or security. The contract obligates the seller to meet the delivery terms if the buyer exercises the contract right. The life of an option contract ends on the expiration date. This is the last day which an option may be traded and is usually the third Friday of the expiration month. As such, option contracts trade from issuance up to expiration.

The strike price is the price at which an option holder can purchase or sell the underlying security. Strike prices are set and do not trade. The buyer of an option contract pays the seller of the contract a premium for the purchase of the contract.

There are two types of option contracts: a call and a put. A call is an option contract that gives the buyer of the contract (the holder or owner of the call option) the right to buy the underlying stock at the strike price any time on or before the expiration date. A call gives the seller of the contract the obligation to sell the underlying stock at the strike price if the option is exercised by the buyer. The call option gets its name because the buyer of the option contract has the right to call away the underlying stock from the seller at anytime during the life of the option.

A put is an option contract that gives the buyer of the contract (the holder or owner of the put option) the right to sell the underlying stock at the strike price any time on or before the expiration date. A put gives the seller of the contract the obligation to buy the underlying stock at the strike price if the option is exercised. The put option gets its name because the buyer of the option contract has the right to put the underlying stock over to the seller at anytime during the life of the option.

There are basically three types of strategies when dealing with options. The first is speculation. If an investor anticipates a certain directional movement in the price of a stock, the right to buy or sell that stock at a set (strike) price by purchasing an option contract can offer an attractive investment opportunity. The decision as to the type of option to buy depends on whether an investor's outlook with regard to the particular stock is positive (bullish) or negative (bearish). If an investor anticipates an upward movement in the stock, a call option offers an opportunity to share the upside potential of the stock. Alternatively, if the investor anticipates a downward movement in the stock, a put option protects against the downside risk without limiting profit potential. Options therefore give investors the opportunity to leverage a relatively small investment into a large profit by purchasing an option contract at a fraction of a stock's market value.

The second and third types of option strategies are hedging and income strategies. The definition of hedging is an equal but opposition position in the options market compared to the investor's position in the stock market. An example of a hedge is owning 100 shares of a stock and buying one put option contract to offset the risk of the stock going down in value. Income strategies involves using options to bring in extra income when the stock that the investor owns does not move up or down in value. The most common income strategy is owning 100 shares of a stock that has not moved and, to bring in some income, the investor sells one call option. The logic is that the stock will not move, the option will expire worthless and the seller of the option gets to keep the premium.

In addition or as an alternative to straight options trading, an investor may choose to invest in option spreads. An option spread is an investment that involves buying and selling option contracts on calls or puts simultaneously. While there are dozens of different types of spreads that experienced option traders deal with, there are essentially four basic types of option spreads: a bull call spread (or debit call spread), a bear call spread (or credit call spread), bear put spread (or debit put spread) and a bull put spread (or credit put spread). Each option spread includes two legs. Each leg has the same number of option contracts, different strike prices, expire on the same date, are of the same options type (call or put) and one will be a buy (of contract(s)) and the other a sell (of contract(s)).

In a Bull Call Spread, the investor buys the lower call strike price and simultaneously sells the higher call strike price for a net debit. This is a bullish spread or strategy.

In a Bear Call Spread, the investor sells the lower call strike price and simultaneously buys the higher call strike price for a net credit. This is a bearish spread or strategy.

In a Bear Put Spread, the investor buys the higher put strike price and simultaneously sells the lower put strike price for a net debit. This is a bearish spread or strategy.

In a Bull Put Spread, the investor sells the higher put strike price and simultaneously buys the lower put strike price for a net credit. This is a bullish spread or strategy.

Options must be understood to be used effectively and intelligently as an investment tool. Investors lacking option experience, however, can trade options through their brokers just by signing an option agreement document. In other words, the investor can have absolutely zero training or background in options, but his or her broker will give them the ability to trade options as long as they sign the options agreement document, which merely lists the risks associated with options. Often times, investors will sign the document without even reading it. As a result, there is a strong demand for a tool that trains and helps investors make informed decisions through guidance that most brokerage firms will not provide to their clients.

Furthermore, options trading, especially when option spreads are involved, is sophisticated and the strategies are complex. Presently available options trading products are designed for professional traders. These products are based on heavy mathematics and require a user to have strong mathematical skills. In addition, most investors will place an options trade without even knowing what the maximum loss, breakeven and maximum profit levels are. As a result, there is a demand for a product that is useful to teach new investors the fundamentals of basic option calculations and how to set up spreads as well as to enable experienced investors to test the profitability of option strategies and analyze different types of spread scenarios.

A demand also exists for an options calculation tool that provides extensive error trapping capability. Such a product would enable a novice investor to learn about options and to avoid mistakes that are so common for beginning option traders. In addition, such a product would help stock brokers avoid errors in calculations as they typically do several different tasks simultaneously while talking on the phone with their clients. Furthermore, stock brokers usually do not have the time to check their work since they are usually on tight time constraints.

Accordingly, it is an object of the present invention to provide an options calculator that calculates the maximum loss, breakeven level and maximum profit for basic option strategies and spread types.

It is another object of the present invention to provide an options calculator that is quick and easy to use.

It is another object of the present invention to provide an options calculator that provides a “What if?” feature that permits an investor to analyze option scenarios.

It is still another object of the present invention to provide an options calculator that allows an investor to analyze different types of spread scenarios.

It is still another object of the present invention to provide an options calculator that provides error trapping and “Help” features such as a glossary of terms so as to instruct a novice investor.

These and other objects and advantages will be apparent from the following specification.

### SUMMARY OF THE INVENTION

The present invention is directed to an options calculator for analyzing simple options and option spreads. The simple options calculator permits a user to input into the calculator a stock name, a month of expiration of the option, a type of transaction (buy or sell), a type of option contract (call or put), a number of option contracts, a strike price and a premium price. Maximum profit, maximum loss and breakeven level are then calculated and displayed to the user. The maximum profit is presented in green, the maximum loss is presented in red and the breakeven level is presented in blue. The simple options calculator also graphically presents a range of stock prices that will result in a profit, a range of stock prices that will result in a loss and the breakeven level. The range of stock prices that will result in a profit is presented in green, the range of stock prices that will result in a loss is presented in red and the breakeven level is presented in blue.

The simple options calculator also includes a “What if?” feature that permits the user to input a stock price or a premium price and a resulting profit or loss is calculated and presented to the user. The “What if?” feature also reports if the option will be exercised, assigned, expire worthless or breakeven in response to the input stock price.

With the option spreads calculator, a stock name, the type of transaction (buy or sell), the type of option contract (call or put), the number of option contracts, the strike price and the premium price initially input are for a first leg of an option spread. The user also inputs a second strike price and a second premium price for a second leg of the option spread and the maximum profit, maximum loss and breakeven level for the option spread are calculated and presented to the user (also in green, red and blue, respectively). The type of spread, resulting debit or credit and break down of each leg are also presented to the user.

Both the simple options calculator and option spreads calculator present error messages and include a help function that may be accessed by the user which includes a glossary of terms.

The following detailed description of embodiments of the invention, taken in conjunction with the appended claims and accompanying drawings, provide a more complete understanding of the nature and scope of the invention.

### BRIEF DESCRIPTION OF THE DRAWINGS

FIG. 1 shows a personal computer suitable for use as a platform for an embodiment of the options calculator of the present invention;

FIG. 2 shows the initial screen presented to a user via a display in an embodiment of the options calculator of the present invention;

FIG. 3 shows the simple options calculator main screen presented to a user in an embodiment of the options calculator of the present invention when the “Simple Options” selection is made from the initial screen of FIG. 2;

FIG. 4 is a flowchart of user inputs and the processing performed by the simple options calculator portion of an embodiment of the options calculator of the present invention;

FIGS. 5A-5D show the simple options calculator main screen after data has been entered and a calculation has been performed and illustrating operation of the “What if?” feature;

FIG. 6 shows an example of an error trapping screen presented to a user in an embodiment of the options calculator of the present invention;

FIG. 7 shows the menu that is displayed when the “Help” function is selected from the simple options calculator screens of FIG. 3 or 5A-5D;

FIG. 8 shows a glossary screen that may be selected from the “Help” menu screen of FIG. 7;

FIG. 9 shows the option spreads calculator main screen presented to a user in an embodiment of the options calculator of the present invention when the “Option Spreads” selection is made from the initial screen of FIG. 2;

FIG. 10 is a flowchart of user inputs and the processing performed by the option spreads calculator portion of an embodiment of the options calculator of the present invention;

FIG. 11 shows the option spreads calculator main screen after data has been entered and a calculation has been performed;

FIG. 12 shows an example of an error trapping screen presented to a user in an embodiment of the option spreads calculator of the present invention;

FIG. 13 shows the menu that is displayed when the “Help” function is selected from the option spreads calculator screens of FIG. 9 or 12;

FIG. 14 shows a glossary screen that may be selected from the “Help” menu screen of FIG. 13;

FIG. 15 shows a network environment suitable for use with an embodiment of the options calculator of the present invention.

### DESCRIPTION OF THE PREFERRED EMBODIMENTS

The invention is an options calculator for use in relation to securities that permits a user to learn about and analyze either simple options or option spreads. As a result, the invention is useful to both new and experienced investors. In addition, it may be used by stock brokers to assist their option clients.

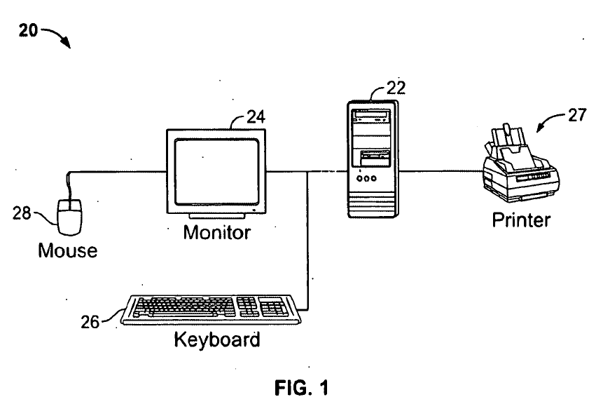

A representative system suitable for carrying out the options calculator of the invention is indicated in general at 20 in FIG. 1. A programmed, general purpose computer 22 including a processor or microprocessor, memory storage (read only memory (ROM) and random access memory (RAM)) and so-called personal computer (“PC”) architecture is provided with peripherals including a display, such as monitor 24, a keyboard 26, printer 27 and a mouse 28. The options calculator of the invention preferably runs on Macromedia Flash 7.0 technology which is present on computer 22. The computer 22 of FIG. 1 preferably also includes a compact disk (“CD”) drive so that the options calculator software may be downloaded or run off of a CD itself. The options calculator software may alternatively be stored on other types of machine-readable mediums. Printouts of any of the calculations or screens described below may be obtained via printer 27.

The options calculator of the present invention could alternatively be implemented on a handheld computer device/system featuring a microprocessor, memory storage and a display such as a personal data assistant (PDA) that is programmed to operate in accordance with the invention as described below. An example of a suitable PDA is one of the PALM family of devices manufactured by 3Com Corporation of Santa Clara, Calif. Such an arrangement offers the advantage of a portable device that may be used virtually anywhere, including in an options trading pit.

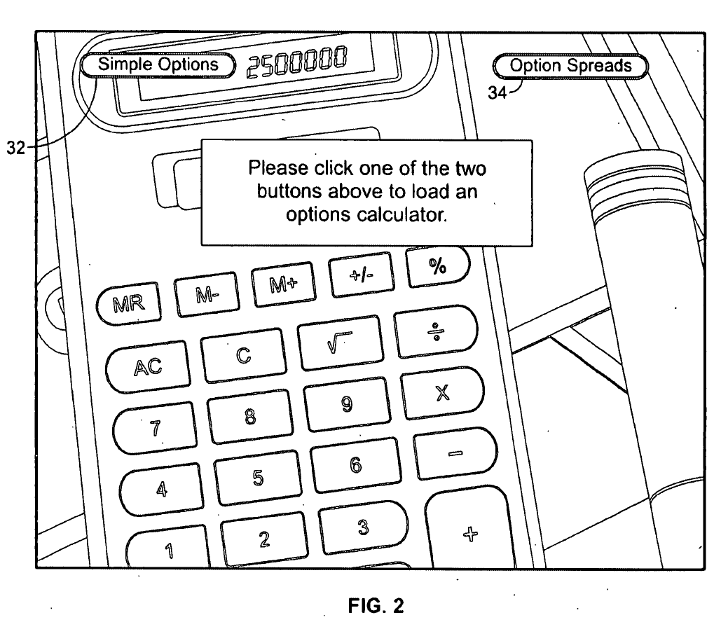

When a user first accesses the options calculator of the present invention on the system 20 of FIG. 1, the initial screen of FIG. 2 is presented on the monitor display 24. The user may select from the initial screen of FIG. 2 either a Simple Options icon 32 or an Option Spreads icon 34. The user clicks on the appropriate selection to access one of the invention's two types of calculators: a simple options calculator or an option spreads calculator. Each will be discussed in turn below.

Simple Options Calculator

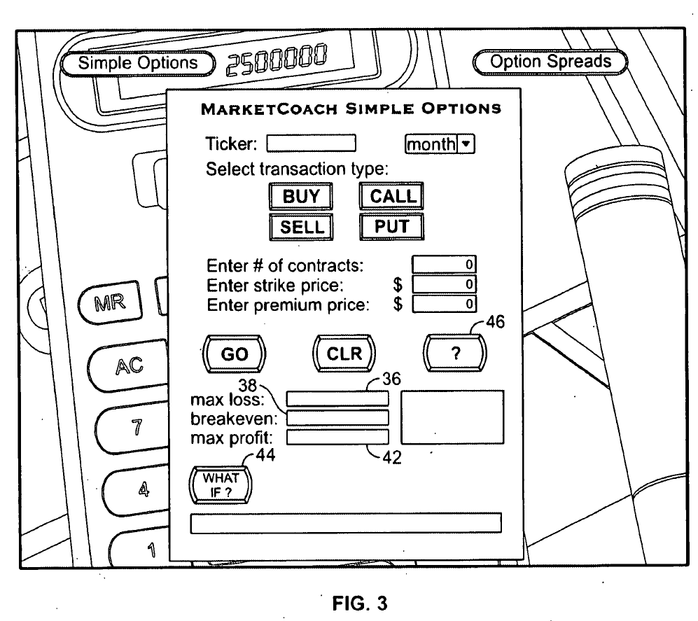

The simple options calculator, which is accessed by selecting icon 32 on the screen of FIG. 2, features a main screen that is illustrated in FIG. 3. It permits a user to compute the maximum loss, breakeven level and maximum profit on the four basic option strategies: buy call, sell call, buy put and sell put. The maximum loss (displayed in the “max loss” window 36 in FIG. 3) is the maximum loss on the data that is entered into the simple options calculator. In some cases it may be unlimited. The breakeven level (displayed in the “breakeven” window 38 in FIG. 3) is the stock price where the investor will break even on the option strategy. The maximum profit (displayed in the “max profit” window 42 in FIG. 3) is the maximum profit for the data that has been entered. In some cases it may also be unlimited. In addition to the above calculations, the simple options calculator features a “What if?” feature, which is selected by button or icon 44, and a “Help” feature, which is selected by icon 46. Both of these features will be discussed below.

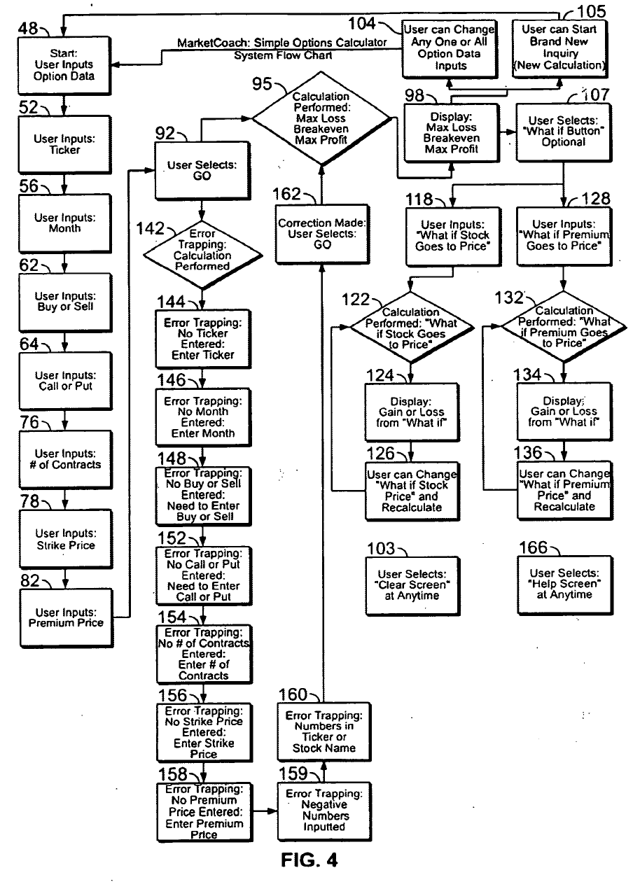

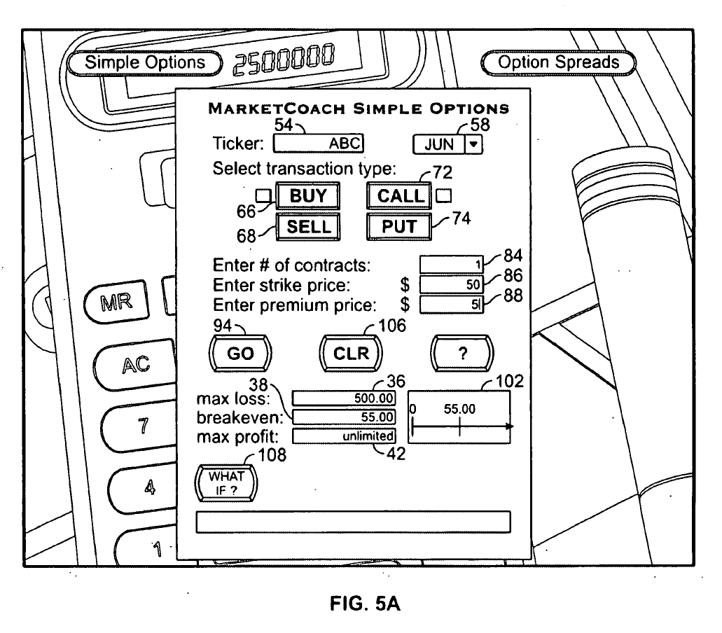

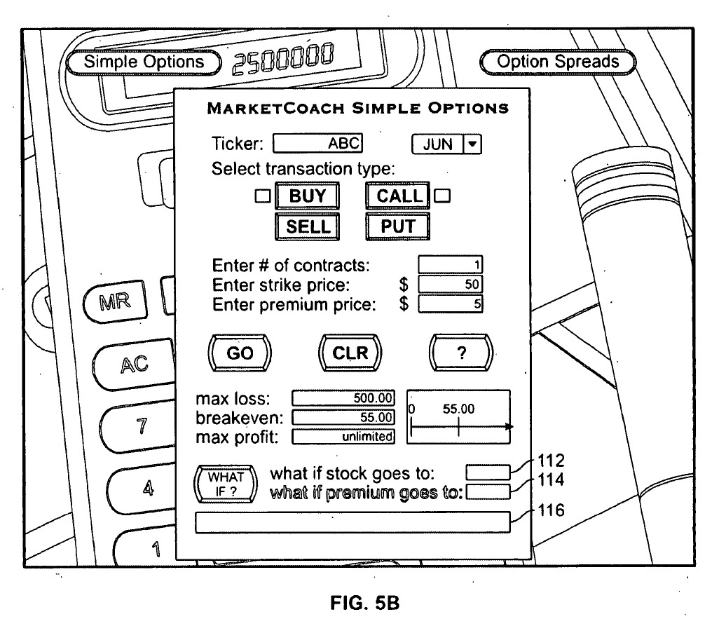

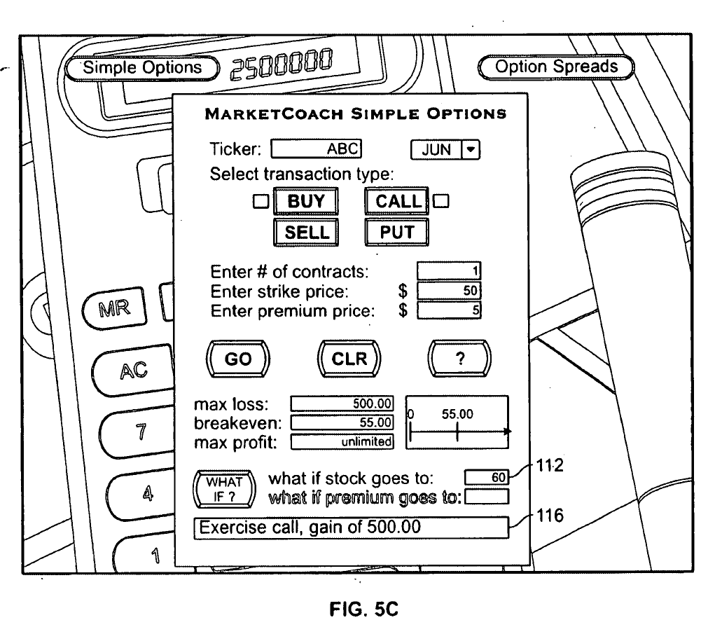

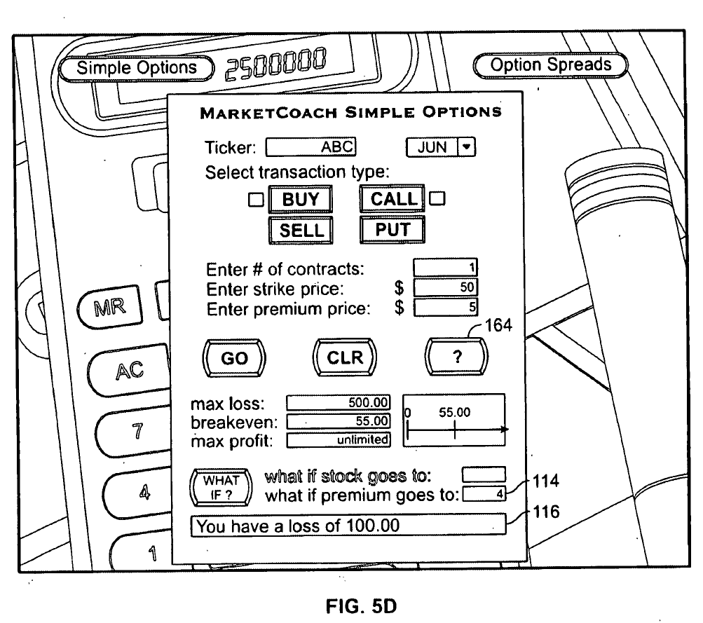

A flowchart illustrating the user inputs and processing performed by the simple options calculator software is illustrated in FIG. 4. As indicated by block 48, the user starts by selecting the simple options calculator main screen of FIG. 5A (and FIG. 3) so that data may be entered. As indicated by block 52 of FIG. 4, the user then enters into field 54 of the screen of FIG. 5A the ticker symbol (or name) of the stock upon which the option is based. As an example, “ABC” has been entered as the stock ticker symbol in FIG. 5A. As indicated by block 56 in FIG. 4, the month of expiration of the option is next entered in field 58 of the screen of FIG. 5A (“Jun” for example). Field 58 is preferably includes a pulldown type menu listing all of the months of the year.

As indicated by blocks 62 and 64 of FIG. 4, the user then clicks on either the Buy or Sell button or icon, illustrated at 66 and 68, respectively, in FIG. 5A, to select the type of transaction and the Call or Put icon, illustrated at 72 and 74, respectively, in FIG. 5A, based on the type of option contract being analyzed. A “Buy Call” option has been selected as an example in FIG. 5A. The software will not permit the user to select both a Call and a Put simultaneously, nor may the user select a Buy and Sell simultaneously.

As illustrated by blocks 76, 78 and 82 in FIG. 4, the user then enters the number of options contracts and the strike and premium prices into fields 84, 86 and 88, respectively, of the screen of FIG. 5A. As an example, 1, $50 and $5 have been entered into fields 84, 86 and 88, respectively, in FIG. 5A. It is to be understood that the user of the calculator can enter the data in any order as long as all the data fields of the calculator are entered.

As indicated by block 92 of FIG. 4, the user next clicks on the “GO” button, illustrated at 94 in FIG. 5A. As a result, the maximum loss, breakeven level and maximum profit are calculated, as indicated at 95 of FIG. 4, and, as indicated by block 98 in FIG. 4, these values are displayed in windows 36, 38 and 42 of FIG. 5A if no errors occurred during data entry. The “max loss” amount of $500 is presented in red, the “breakeven” of $55 is presented in blue and “max profit” information (unlimited) is presented in green.

The calculations performed at 95 in FIG. 4 are straightforward and based on simple mathematical equations. Example calculations and the formulas used by the simple options calculator for the four basic option strategies are as follows:
1. Buying a Call (illustrated in FIG. 5A)
Example: Buy 1 ABC June $50 Call at $5
Maximum Loss=Premium Price×100
   $5×100=
   $500
Breakeven=Strike price+Premium Price
   $50+$5=
   $55
Maximum Profit=Unlimited
2. Selling a Call
Example: Sell 1 ABC June $50 Call at $5
Maximum Loss=Unlimited
Breakeven=Strike Price+Premium Price
   $50+$5=
   $55
Maximum Profit=Premium Price×100
   $5×100=
   $500
3. Buying a Put
Example: Buy 1 ABC June $50 Put at $5
Maximum Loss=Premium Price×$100
   $5×$100=
   $500
Breakeven=Strike Price−Premium Price
   $50−$5=
   $45
Maximum Profit=Occurs when stock price falls to zero.
   Strike Price−Premium Price×100
   $50−$5=$45
   $45×100=
   $4,500
4. Selling a Put
Example: Sell 1 ABC June $50 Put at $5
Maximum Loss=Occurs when stock price falls to zero.
   Strike Price−Premium×100
   $50−$5=$45
   $45×100=
   $4,500
Breakeven=Strike Price−Premium Price
   $50−$5=
   $45
Maximum Profit=Premium Price×100
   $5×100=
   $500

The information displayed in windows 36, 38 and 42 of the screen of FIG. 5A is also presented graphically in window 102 of the screen of FIG. 5A with respect to stock price. More specifically, window 102 indicates in red a range of stock prices that will result in a loss, in blue the stock price corresponding to the breakeven level and in green a range of stock prices that will result in a profit. With regard to the example data that was entered in FIG. 5A, the breakeven level of $55 is indicated in blue. The portion of the graph 102 between “0” and “55” (to the left of the breakeven level) is displayed in red indicating that if the stock price is between $0 and $55, and if the option is exercised, a loss will result. As a result, an option investor would never exercise the option between $0 and $55 because this would put them in a losing position. Basically, for any value in this range, the option investor would let the call expire worthless and lose their initial investment (which would equal the premium paid for a long call). Conversely, the portion of the graph 102 corresponding to $55 and up (to the right of the breakeven level) is displayed in green indicating that if the stock price is over $55, a profit will be made if the option is exercised.

As indicated by block 104 in FIG. 4, the user is able to change the number of contracts in field 84 of the screen of FIG. 5A, the strike price in field 86 or the premium price in field 88 and the calculator instantly updates windows 36, 38, 42 and 102 without the user having to click on the “GO” button 94 of the screen of FIG. 5A. As indicated in block 105 of FIG. 4, if the user wishes to start over with a totally new scenario or inquiry, he or she may press the “CLR” button 106 of the of FIG. 5A to clear all of the windows and fields of the screen. As indicated by block 103 in FIG. 4, the user may press the “CLR” button anytime to clear the fields and/or windows of the screen of FIG. 5A.

Once an initial calculation has been performed, such as the one illustrated in FIG. 5A, the user may analyze the scenario by using the “What if?” feature of the simple options calculator. To use this feature, as indicated by block 107 in FIG. 4, the user clicks on the “WHAT IF?” button, indicated at 108 in FIG. 5A. As a result, a “what if stock goes to:” field 112 and “what if premium goes to:” field 114 are displayed as illustrated in FIG. 5B. The user then has the choice of analyzing the option based upon either stock price or premium price. More specifically, if the user specifies a stock price, the calculator figures profit or loss and reports it and if the option will be exercised, assigned, expire worthless or break even in window 116. If the user specifies a premium, the calculator computes and reports the profit or loss in window 116. The software will not allow the user to get “WHAT IF?” answers until all necessary entries have been made into the calculator (number of contracts, etc.).

For example, as illustrated in FIG. 5C, and using the example data entered in FIG. 5A, if the user enters a stock price of $60 in field 112, the option will be exercised and he or she will obtain a gain of $500, as indicated in the window 116. These steps are illustrated by blocks 118, 122 and 124 of FIG. 4. As illustrated by block 126, the user may change the stock price in field 112 and a new value will be displayed in window 116. The information of window 116 in FIG. 5C is displayed in green since it is a gain. If the scenario resulted in a loss, the information would be presented in window 116 in red.

As illustrated in FIG. 5D, if the user alternatively enters a premium price of $4 in field 114, the window 116 beneath indicates a loss of $100 (in red). These steps are illustrated by blocks 128, 132 and 134 in FIG. 4. As illustrated by block 136, the user may change the premium price in field 114 and a new value will be displayed in window 116.

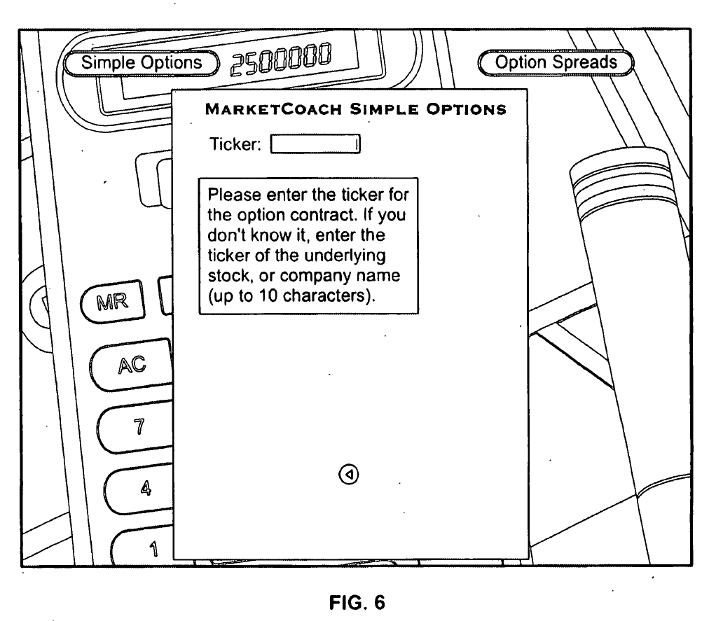

The simple options calculator provides extensive error trapping capability to facilitate use and to reduce the chance of investor and broker mistakes. As illustrated by block 142 in FIG. 4, after the user selects “GO”, the fields of the simple options calculator main screen (FIGS. 3 and 5A-5D) are checked by the software. If any of the fields do not contain entries, or contain inappropriate entries, appropriate error messages are displayed, as illustrated by blocks 144, 146, 148, 152, 154, 156, 158, 159 and 160 in FIG. 4. In response to the displayed error message, as illustrated by block 162 in FIG. 4, the user enters the missing data and once again selects “GO” so that the calculations 95 of FIG. 4 are performed. An example of the error message displayed via block 144 of FIG. 4 is illustrated in FIG. 6.

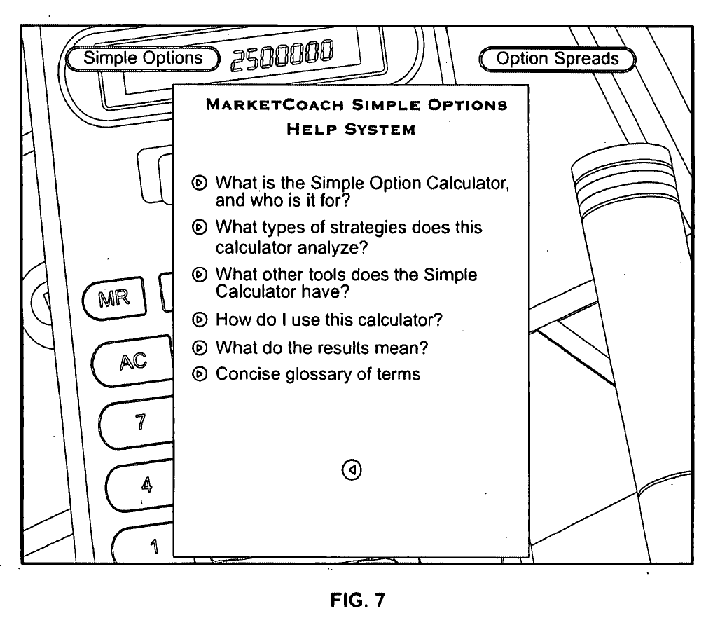

To the right of the “GO” and “CLR” buttons is a button labeled “?” (illustrated at 164 in FIG. 5D). As indicated by block 166 in FIG. 4, the user may select this button anytime. The “?” button is essentially a “Help” button that activates a help function to provide the user with information on the calculator, the information that it provides and how to use it. FIG. 7 shows an example of a screen that may be displayed when the “?” button is selected. This screen provides the user with a list of questions that the user may have along with an icon positioned next to each question. One or more screens providing the answer to a listed question are displayed when the user clicks on the icon next to the question. If the user has entered any data prior to selecting the “?” button, that data is still present when the user returns from the help screen.

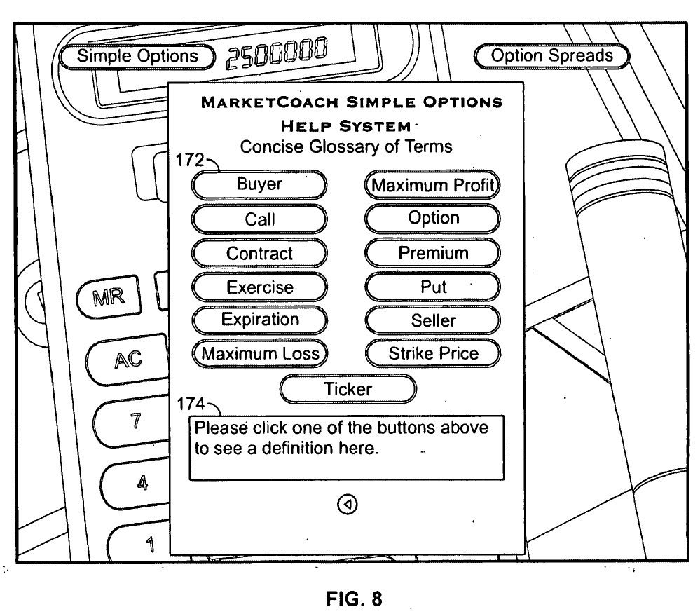

The options available when the “?” button is selected preferably include a glossary of terms (the last entry on the screen of FIG. 7). In the preferred embodiment, selecting the glossary option from the screen of FIG. 7 results in the screen of FIG. 8 being displayed. As indicated at 172, the glossary screen of FIG. 8 preferably includes a number of buttons or icons, each labeled with a term relating to the simple options calculator. Selecting one of the buttons 172 results in a corresponding definition appearing in window 174.

The numerous options of FIG. 7 and the glossary of FIG. 8 enable the simple options calculator to be a useful learning aid for users of all levels.

Option Spreads Calculator

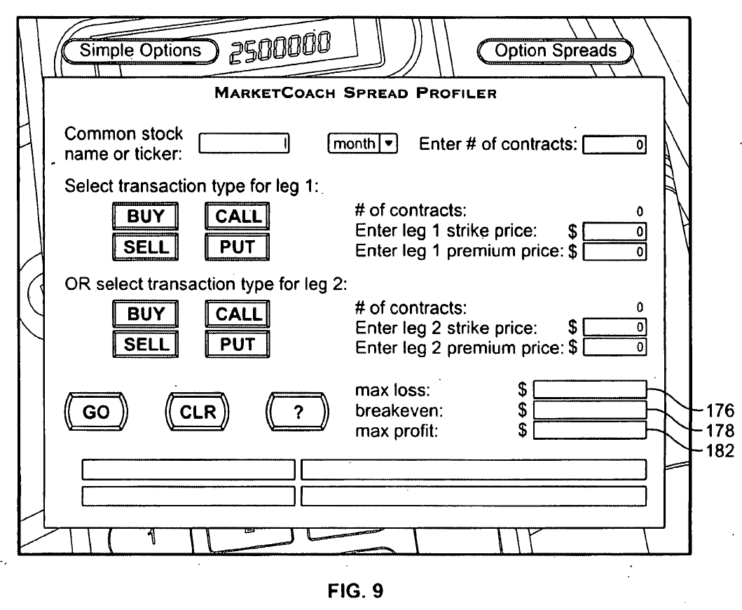

The options spreads calculator of the present invention may be accessed by selecting icon 34 from the initial screen shown in FIG. 2. After this selection is made, the option spreads calculator main screen, illustrated in FIG. 9, is displayed to the user.

The option spreads calculator enables the user to compute the maximum loss, breakeven level and maximum profit on the four basic option spread strategies or types: bull call spread (or debit call spread), bear call spread (or credit call spread), bear put spread (debit put spread) and bull put spread (credit put spread). The maximum loss (displayed in the “max loss” window 176 in FIG. 9) is the maximum loss on the spread data that is entered into the option spreads calculator. The breakeven level (displayed in the “breakeven” window 178 in FIG. 9) is the stock price point where the investor will break even on the investment. The maximum profit (displayed in the “max profit” window 182 in FIG. 3) is the maximum profit possible on the spread data that has been entered. In some cases it may be unlimited.

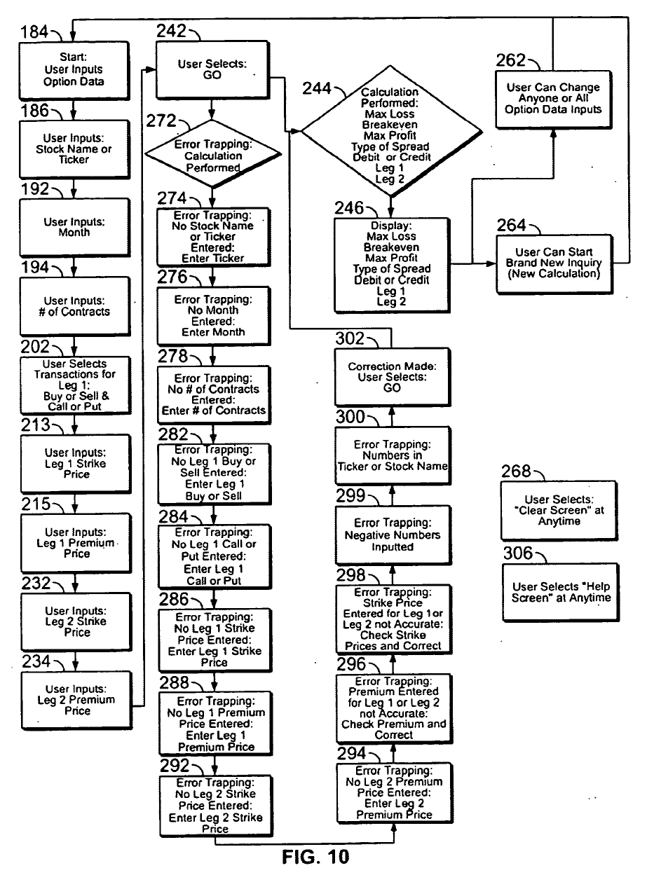

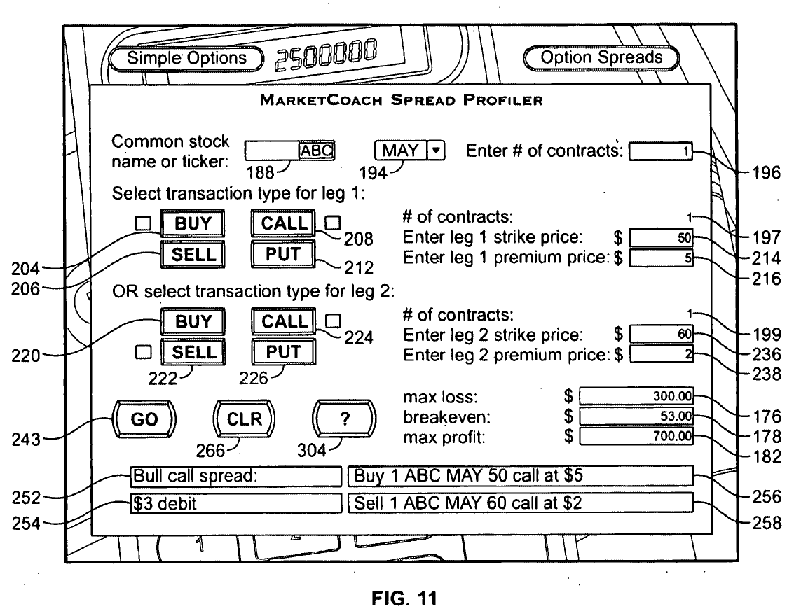

A flowchart illustrating the user inputs and processing performed by the option spreads calculator software is illustrated in FIG. 10. As indicated by block 184, the user starts by selecting the option spreads calculator main screen of FIG. 11 (and FIG. 9) so that data may be entered. As indicated by block 186 of FIG. 10, the user then enters into field 188 of the screen of FIG. 11 the ticker symbol (or name) of the stock upon which the option is based. As an example, “ABC” has been entered as the stock ticker symbol in FIG. 11. As indicated by block 192 in FIG. 10, the month of expiration of the option is next entered in field 194 of the screen of FIG. 11 (“May” for example). Field 194 preferably includes a pulldown type menu listing all of the months of the year.

As described previously, an option spread is an investment that involves buying and selling option contracts on calls or puts simultaneously. An option spread has two separate legs (leg 1 and leg 2). Each leg has the same number of contracts, different strikes prices, same month, same option contract type (call or put) and different types of transactions (one leg will be a buy while the other is a sell).

As illustrated by block 194 of FIG. 10, the user enters the number of contracts in field 196 of the screen illustrated in FIG. 11. One contract has been entered as an example in FIG. 11. The number of contracts automatically appear in windows 197 and 199 of the screen of FIG. 11 and are equal.

Next, as illustrated by block 202 of FIG. 10, the user clicks on the one of the Buy or Sell boxes, 204 and 206 in FIG. 11, and one of the Call or Put boxes, 208 and 212 in FIG. 11, for leg 1 of the spread. A “Buy Call” has been selected as an example for leg 1 in FIG. 11. As illustrated by blocks 213 and 215 of FIG. 10, the user then enters the leg 1 strike and premium prices in fields 214 and 216 of FIG. 11 (for example, $50 and $5, respectively, in FIG. 11).

As mentioned previously, the number of contracts for leg 2 automatically equals the number of contracts for leg 1. In addition, the appropriate Buy or Sell boxes (220 and 222 in FIG. 11) and Call or Put boxes (224 and 226 in FIG. 11) are automatically selected for leg 2 based upon those selected for leg 1. For the example illustrated in FIG. 11, since the user clicked on the Buy box (204) for leg 1, the Sell box (222) is automatically selected for leg 2. Furthermore, since the user selected the Call box (208) for leg 1, the Call box (224) is automatically selected for leg 2. As illustrated by blocks 232 and 234 in FIG. 10, the user then enters the strike and premium prices in fields 236 and 238 of the screen of FIG. 11 (for example, $60 and $2, respectively, in FIG. 11) for leg 2.

As in the case of the simple options calculator, it is to be understood that the user of the calculator can enter the data in any order as long as all the data fields of the calculator are entered.

As illustrated by block 242 of FIG. 10, the user then clicks on the “GO” button, illustrated at 243 in FIG. 11, and the maximum loss, breakeven level and maximum profit calculated, as illustrated by block 244 of FIG. 10. In addition, the three values are displayed in windows 176, 178 and 182 ($300, $53 and $700, respectively in FIG. 11) as illustrated by block 246 in FIG. 10. As with the simple options calculator, loss information is presented in red, profit information is presented in green and the breakeven is presented in blue.

As indicated in blocks 244 and 246 of FIG. 10, additional information regarding the option spread is calculated and appears in the four windows 252, 254, 256 and 258 of FIG. 11. This information includes the type of spread that the investor is placing in window 252 (“Bull call spread” in FIG. 11), the credit or debit of the spread in window 254 ($3 debit in red in FIG. 11) and lists each leg of the spread in windows 256 and 258 of FIG. 11 for ease of analysis. Window 254 displays a debit in red and a credit in green.

The calculations performed at 244 in FIG. 10 are straightforward and are based on simple mathematical equations. Example calculations and the formulas used by the option spreads calculator for the four basic option spreads strategies are as follows:
1. Bull Call Spread (illustrated in FIG. 11)
Moderately Bullish Strategy
Buy low Strike price/Sell high Strike price
Example:
Buy 1 ABC May $50 call at $5
Sell 1 ABC May $60 call at $2
Maximum Loss=(Leg 1 premium−Leg 2 premium)×100
   $5−$2=$3
   $3×100=
   $300
Breakeven=Long Strike Price+Net debit
   $50+$3=
   $53
Maximum Profit=(Difference between strike prices)−(Net debit)×100
   $60−$50−$3=
   $10−$3=$7
   $7×10.0=
   $700
2. Bear Call Spread
Moderately Bearish Strategy
Sell Low Strike price/Buy High Strike price
Example:
Sell 1 ABC May $50 call at $5
Buy 1 ABC May $60 call at $2
Maximum Loss=(Difference between strike prices)−(Net Credit)×100
   ($60−$50)−$3=
   $10−$3=$7
   $7×100=
   $700
Breakeven=Sell Strike Price+Net Credit
   $50+$3=
   $53
Maximum Profit=Net Credit×100
   $5−$2=$3
   $3×100=
   $300
3. Bear Put Spread
Moderately Bearish Strategy
Buy High Strike price/Sell Low Strike price
Example:
Buy 1 ABC May $60 Put at $5
Sell 1 ABC May $50 Put at $2
Maximum Loss=(Leg 1 Premium−Leg 2 Premium)×100
   $5−$2=$3
   $3×100=
   $300
Breakeven=Long Strike Price−Net debit
   $60−$3
   $57
Maximum Profit=(Difference in Strike prices)−(Net debit)×100
   ($60−$50)−$3=
   $10−$3=$7
   $7×100=
   $700
4. Bull Put Spread
Moderately Bullish Strategy
Sell High Strike Price/Buy Low Strike Price
Example:
Sell 1 ABC May $60 Put at $5
Buy 1 ABC May $50 Put at $2
Maximum Loss=(Difference in strike prices)−(net credit)×100
   $60−$50−$3=
   $10-$3=$7
   $7×100=
   $700
Breakeven=Short Strike Price−Net Credit
   $60−$3=
   $57
Maximum Profit=Net Credit×100
   $3×100=
   $300

As illustrated by block 262 of FIG. 10, if any of the calculator data fields of the screen of FIG. 11 are changed, the answers are instantaneously updated automatically without the user having to click on the “GO” button again. As indicated in block 264 of FIG. 10, if the user wishes to start over with a totally new scenario or inquiry, he or she may press the “CLR” button 266 of the of FIG. 11 to clear all of the windows and fields of the screen. As indicated by block 268 in FIG. 10, the user may press the “CLR” button anytime to clear the fields and/or windows of the screen of FIG. 11.

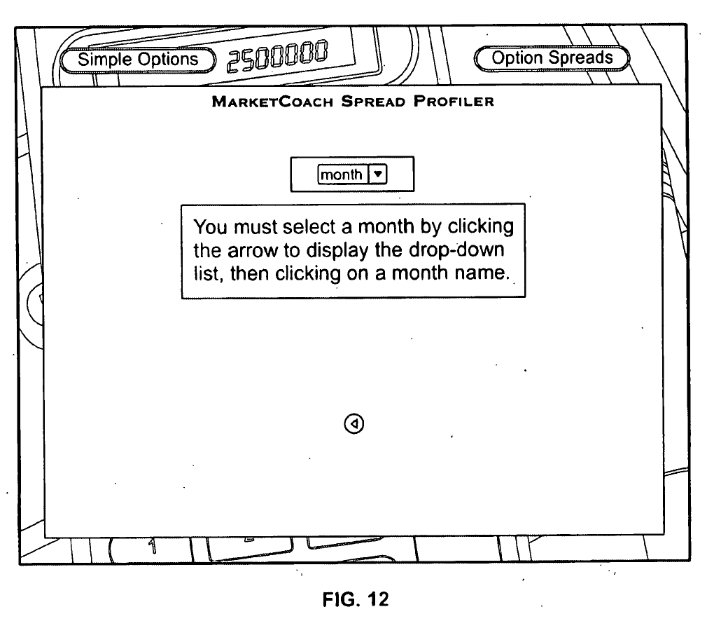

As with the simple options calculator, the option spreads calculator provides extensive error trapping capability to facilitate use and to reduce the chance of investor and broker mistakes. As illustrated by block 272 in FIG. 10, after the user selects “GO”, the fields of the option spreads calculator main screen (FIGS. 9 and 11) are checked by the software. If any of the fields do not contain entries, or contain erroneous entries, appropriate error messages are displayed, as illustrated by blocks 274, 276, 278, 282, 284, 286, 288, 292, 294, 296, 298, 299 and 300 in FIG. 10. In response to the displayed error message, as illustrated by block 302 in FIG. 10, the user enters the missing data and once again selects “GO” so that the calculations 244 of FIG. 10 are performed. An example of the error message displayed via block 276 of FIG. 10 is illustrated in FIG. 12.

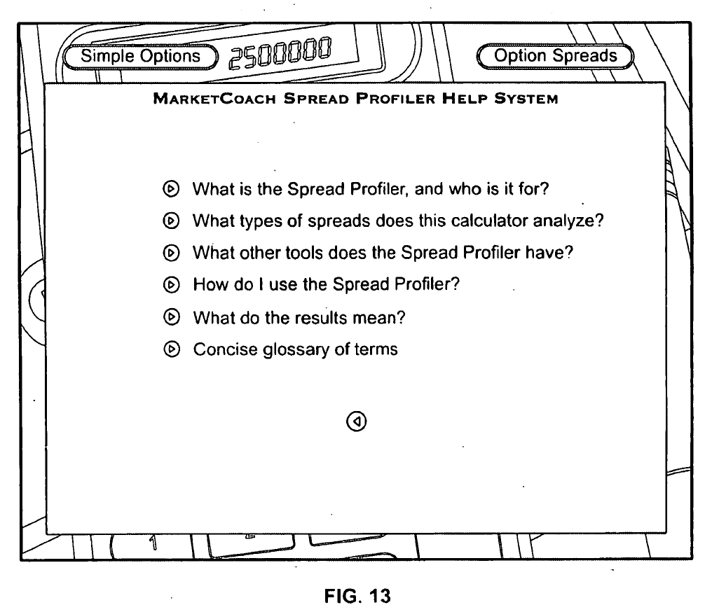

To the right of the “GO” and “CLR” buttons is a button labeled “?” (illustrated at 304 in FIG. 11). As indicated by block 306 in FIG. 10, the user may select this button anytime. As with the simple options calculator, the “?” button is essentially a “Help” button that activates a help function to provide the user with information on the calculator, the information that it provides and how to use it. FIG. 13 shows an example of a screen that may be displayed when the “?” button is selected. This screen provides the user with a list of questions that the user may have along with an icon positioned next to each question. One or more screens providing the answer to a listed question are displayed when the user clicks on the icon next to the question. If the user has entered any data prior to selecting the “?” button, that data is still present when the user returns from the help screen.

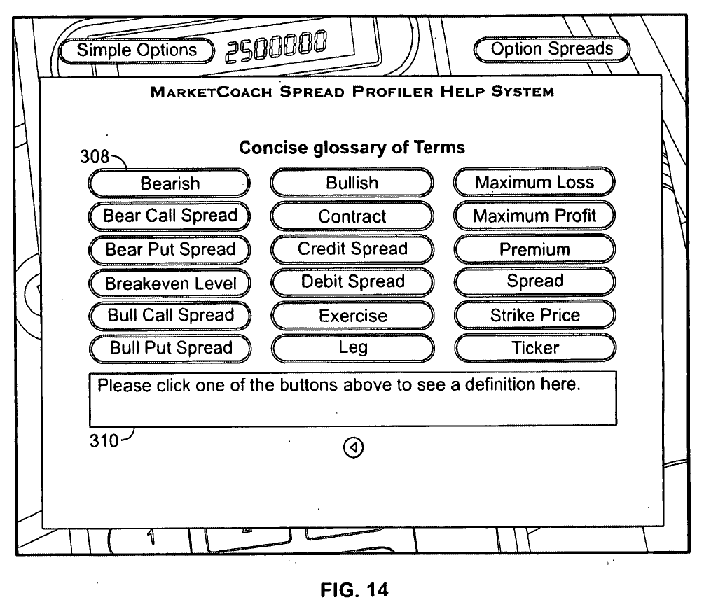

As with the simple options calculator, the options available when the “?” button is selected preferably include a glossary of terms (the last entry on the screen of FIG. 13). In the preferred embodiment, selecting the glossary option from the screen of FIG. 13 results in the screen of FIG. 14 being displayed. As indicated at 308, the glossary screen of FIG. 14 preferably includes a number of buttons or icons, each labeled with a term relating to the option spread calculator. Selecting one of the buttons 308 results in a corresponding definition appearing in window 310.

As with the simple options calculator, the numerous options of FIG. 13 and the glossary of FIG. 14 enable the option spreads calculator to be a useful learning aid for users of all levels.

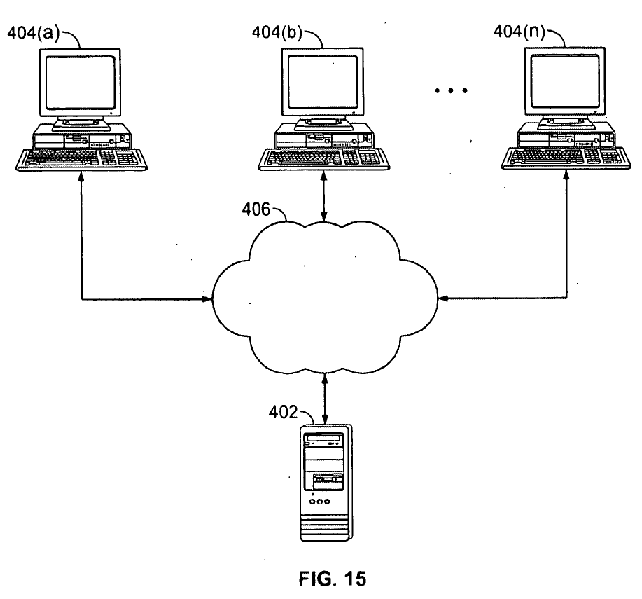

As an alternative to the embodiment illustrated in FIG. 1, the options calculator of the invention may be configured so as to provide access to multiple users via the Internet. More specifically, as illustrated in FIG. 15, a server is loaded with the options calculator software. The server communicates with a number of user computers 404(a) through 404(n) through a network 406 such as the Internet. As a result, each of the user computers may used to access an use the options calculator resident on the server.

While the preferred embodiments of the invention have been shown and described, it will be apparent to those skilled in the art that changes and modifications may be made therein without departing from the spirit of the invention, the scope of which is defined by the appended claims.

What is claimed is:

1. A system for analyzing options comprising:
a) memory storage having software where the software permits a user to input into the system a type of transaction, a type of option contract, a number of option contracts, a strike price and a premium price;
b) a processor in communication with said memory storage and using the software to calculate a maximum loss, breakeven level and maximum profit based on the type of transaction, type of option contract, number of option contracts, the strike price and the premium price entered by the user; and
c) a display in communication with the memory storage and the processor, said display presenting to the user the maximum loss, breakeven level and maximum profit.

2. The system of claim 1 wherein the display graphically presents a range of stock prices that will result in a profit, a range of stock prices that will result in a loss and the breakeven level.

3. The system of claim 2 wherein the range of stock prices that will result in a profit is presented in green, the range of stock prices that will result in a loss is presented in red and the breakeven level is presented in a third color.

4. The system of claim 1 wherein the software permits a user to also enter a stock name and a month of expiration of the option.

5. The system of claim 1 wherein the maximum profit is presented in green, the maximum loss is presented in red and the breakeven level is presented in a third color.

6. The system of claim 1 wherein the software permits the user to input a stock price and the processor calculates a resulting profit or loss that is presented to the user on the display.

7. The system of claim 6 wherein the system also reports if the option will be exercised, assigned, expire worthless or breakeven in response to the input stock price.

8. The system of claim 1 wherein the software permits the user to input a premium price and the processor calculates a resulting profit or loss that is presented to the user on the display.

9. The system of claim 1 wherein the software presents an error message on the display if the user has failed to input a required entry or has input an inappropriate entry.

10. The system of claim 1 wherein the software includes a help function that may be accessed by the user.

11. The system of claim 10 wherein the help function presents a list of questions to the user on the display and an answer to a question is presented to the user on the display when an icon corresponding to the question is selected.

12. The system of claim 1 wherein the software includes a glossary of terms that may be accessed by the user.

13. The system of claim 12 wherein the glossary of terms is presented to the user on the display as a plurality of icons where each of the plurality of icons is labeled with a term and a definition of a term is presented to the user on the display when an icon corresponding to the term is selected.

14. The system of claim 1 wherein the type of transaction, the type of option contract, the number of option contracts, the strike price and the premium price input into the system are for a first leg of an option spread and the software permits the user to input a second strike price and a second premium price for a second leg of the option spread and the maximum profit, maximum loss and breakeven level calculated by the processor and presented by the display are for the option spread.

15. The system of claim 14 wherein the processor also determines the type of spread and calculates a resulting debit or credit that are presented to the user on the display.

16. The system of claim 1 further comprising a printer in communication with the processor so that printouts of screens presented on said display may be made.

17. The system of claim 1 wherein said display and said user communicate with the processor via a network.

18. The system of claim 17 wherein the network is the Internet.

19. A method for analyzing options and option spreads comprising the steps of:
a) providing a computer system;
b) inputting a type of transaction into the system;
c) inputting a type of option contract into the system;
d) inputting a number of option contracts from a user;
e) inputting a strike price from the user;
f) inputting a premium price from the user;
g) calculating a maximum loss, breakeven level and maximum profit based on the type of transaction, type of option contract, number of option contracts, the strike price and premium price inputted in steps b) through f); and
h) displaying the maximum loss, breakeven level and maximum profit.

20. The method of claim 19 wherein the type of transaction, the type of option contract, the number of option contracts, the strike price and the premium price input in steps b) through f) are for a first leg of an option spread and further comprising the steps of inputting a second strike price and a second premium price for a second leg of the option spread and the maximum profit, maximum loss and breakeven level calculated in step g) and displayed in step h) are for the option spread.

21. The method of claim 20 further comprising the steps of determining the type of spread and calculating a resulting debit or credit and displaying the type of spread and the debit or credit.

22. A machine-readable medium on which has been prerecorded a computer program which, when executed by a processor, performs the following steps:
a) receiving a type of transaction from a user;
b) receiving a type of option contract from the user;
c) receiving a number of option contracts from the user;
d) receiving a strike price from the user;
e) receiving a premium price from the user;
f) calculating a maximum loss, breakeven level and maximum profit based on the type of transaction, type of option contract, number of option contracts, the strike price and premium price received in steps a) through e); and
g) displaying the maximum loss, breakeven level and maximum profit to the user.

23. The machine-readable medium of claim 22 wherein the type of transaction, the type of option contract, the number of option contracts, the strike price and the premium price received in steps a) through e) are for a first leg of an option spread and the computer program further performing the steps of receiving a second strike price and a second premium price for a second leg of the option spread and wherein the maximum profit, maximum loss and breakeven level calculated in step f) and displayed in step g) are for the option spread.
